(19) United States
(12) Patent Application Publication
(10) Pub. No.: US 2021/0065022 A1
(43) Pub. Date: Mar. 4, 2021

(54) MOTION DATA LABELING SYSTEM, METHOD AND NON-TRANSITORY COMPUTER READABLE MEDIUM

(71) Applicant: INSTITUTE FOR INFORMATION INDUSTRY, Taipei (TW)

(72) Inventors: Wei-Ming CHIANG, Taipei (TW); Kuei-Chien TSAI, Taipei (TW); Chi-Hsien LIU, Taipei (TW)

(21) Appl. No.: 16/748,815

(22) Filed: Jan. 22, 2020

(30) Foreign Application Priority Data
Sep. 3, 2019 (TW) 108131746

(51) Int. Cl. G06N 5/04; G06N 20/00; G06F 16/23

(52) U.S. Cl. CPC G06N 5/04; G06F 16/2379; G06N 20/00

(57) ABSTRACT

A system for labeling motion data includes a memory and a processor. The memory stores instructions. The processor accesses and executes the instructions to perform the following: generate a motion trajectory passage, which includes an initial posture; access unlabeled motion data; determine whether the unlabeled motion data includes the initial posture; in response to the unlabeled motion data including the initial posture, determine whether the unlabeled motion data matches the motion trajectory passage; and in response to the unlabeled motion data matching the motion trajectory passage, attach a label to the unlabeled motion data.

### CROSS-REFERENCE TO RELATED APPLICATION

This application claims priority to Taiwan Application Serial Number 108131746, filed on Sep. 3, 2019, which is herein incorporated by reference.

### BACKGROUND

### Field of Invention

Present disclosure relates to an electronic system, an operating method and a non-transitory computer readable medium. More particularly, the present disclosure relates to a system, a method and a non-transitory computer readable medium for labelling motion data.

### Description of Related Art

In the prior art, collecting and marking a large amount of motion data requires human resources. In such approach, a predetermined start point and a predetermined end point of a specific motion are required. Further, it is necessary to confirm whether each motion is effective. Therefore, an approach that automatically verifies and labels meaningful data from a big data is required.

### SUMMARY

To solve foregoing problems, the present disclosure provides a system, a method and a non-transitory computer readable medium below.

An aspect of the present disclosure relates to a motion data labeling system. The motion data labeling system comprises a memory and a processor. The processor is communicatively coupled to memory. The memory stores at least one instruction. The processor is configured to access and execute the at least one instruction to perform the following: generating a motion trajectory passage based on at least one initial motion data, wherein the motion trajectory passage comprises an initial posture; accessing an unlabeled motion data; determining whether the unlabeled motion data comprises the initial posture; in response to the unlabeled motion data comprising the initial posture, determining whether the unlabeled motion data matches the motion trajectory passage; and in response to the unlabeled motion data matching the motion trajectory passage, attaching a label to the unlabeled motion data.

Another aspect of disclosure relates to a motion data labeling method. The motion data labeling method comprises: generating a motion trajectory passage based on at least one initial motion data, wherein the motion trajectory passage comprises an initial posture; accessing an unlabeled motion data; determining whether the unlabeled motion data comprises the initial posture; in response to the unlabeled motion data comprising the initial posture, determining whether the unlabeled motion data matches the motion trajectory passage; and in response to the unlabeled motion data matching the motion trajectory passage, attaching a label to the unlabeled motion data.

Still another aspect of disclosure relates to a non-transitory computer readable medium. The non-transitory computer readable medium stores at least one computer readable instruction. When the at least one computer readable instruction is executed by a processor, its causes the processor to perform steps comprising: generating a motion trajectory passage based on at least one initial motion data, wherein the motion trajectory passage comprises an initial posture; accessing an unlabeled motion data; determining whether the unlabeled motion data comprises the initial posture; in response to the unlabeled motion data comprising the initial posture, determining whether the unlabeled motion data matches the motion trajectory passage; and in response to the unlabeled motion data matching the motion trajectory passage, attaching a label to the unlabeled motion data.

It is noted that the foregoing descriptions of the present disclosure and the following embodiments are illustrative cases, and the purpose of the descriptions and the embodiments are to explain the details of the scope of the claims.

### BRIEF DESCRIPTION OF THE DRAWINGS

FIG. 1 is a schematic diagram illustrating a motion data labeling system 100 according to some embodiments of the present disclosure.

FIG. 2 flow chart showing a motion data labeling method according to some embodiments of the present disclosure.

FIG. 3 is a schematic diagram illustrating a motion trajectory passage according to some embodiments of the present disclosure.

FIG. 4 is a schematic diagram illustrating a motion data labeling method according to some embodiments of the present disclosure.

FIG. 5 is a schematic diagram illustrating a motion data labeling method according to some embodiments of the present disclosure.

FIG. 6A is a schematic diagram illustrating a similarity calculation process according to some embodiments of the present disclosure.

FIG. 6B is a schematic diagram illustrating a similarity calculation process according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the following description and claims, unit being described with singulars, such as “one”, “the”, “that”, and “this” are not intend to limited the numbers of the described unit.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

As used herein, the terms “comprising,” “including,” “having,” and the like are to be understood to be open-ended, i.e., to mean including but not limited to.

In the following description and claims, the term “and/or” may be used to describe one of a plurality things or a combination or said things.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

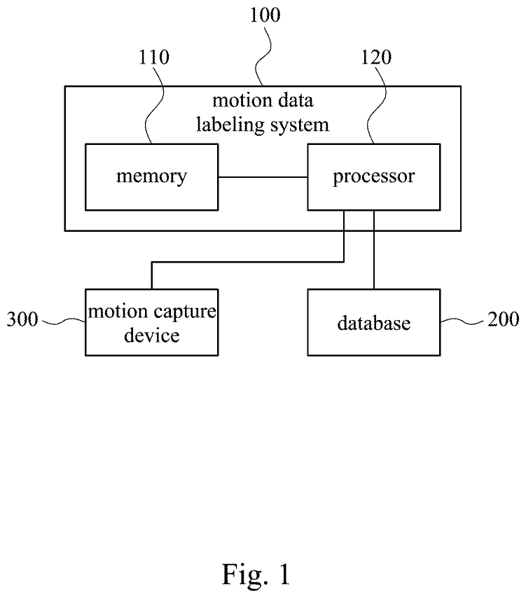

FIG. 1 is a schematic diagram illustrating a motion data labeling system 100 according to some embodiments of the present disclosure. FIG. 1 shows that, in some embodiments, the motion data labeling system 100 can include a memory 110 and a processor 120.

In some embodiments, the memory 110 can include, but not limited to, a flash memory, a hard disk drive (HDD), a solid-state drive (SSD), a dynamic random access memory (DRAM) or a static random access memory (SRAM). In some embodiments, the memory 110 can be a non-transitory computer readable medium that stores at least one computer readable instruction. The computer readable instruction is associated with a motion data labeling method.

In some embodiments, the processor 120 can include, but not limited to, a single processor or an integration of multiple microprocessors, such as an central processing unit (CPU) or graphical processing unit (GPU), etc. The processor can be coupled to some memories. In this manner, the processor 120 can access the computer readable instruction and execute the computer readable instruction, in order to perform specific application program to accomplish the motion data labeling method. To allow for better understandings of the motion data labeling method, following paragraphs can introduce details of the method.

As shown in FIG. 1, in some embodiments, the processor 120 can be selected to be communicatively coupled to the database 200. In some embodiments, the database 200 stores a plurality of initial motion data, especially the initial motion data of people performing at least one motion. In some embodiments, the database 200 can be implemented on a server outside the motion data labeling system 100. In some embodiments, the database 200 can be implemented on the memory 110.

As shown in FIG. 1, the processor 120 can be selected to be communicatively coupled to the motion capture device 300. In some embodiments, the motion capture device 300 can include, but not limited to, optical capture devices (e.g., a general purpose optical capture device, an infrared optical capture device, a highly sensitive optical capture device, or an optical capture device with depth detection) or inertial sensors (e.g., a gyroscope, an accelerometer or others) for capturing motion-related data (e.g., change of quaternions, Euler angles, acceleration causing by the people's acts). In some embodiments, the motion-related data captured by the motion capture device 300 includes mentioned initial motion data.

It is noted that the term “electrical coupling” or “communicatively coupling” can be in a physical manner or a non-physical manner. For example, in some embodiments, the processor 120 can be coupled to the database 200 via physical cables. In some embodiments, the processor 120 can be coupled to the motion capture device 300 based on wireless communication standards. Nevertheless, the ways that the devices coupling to each other are not limited to mentioned embodiments. This coupling allows unidirectional or bidirectional information exchanges between the processor 120 and the database 200 (or the motion capture device 300).

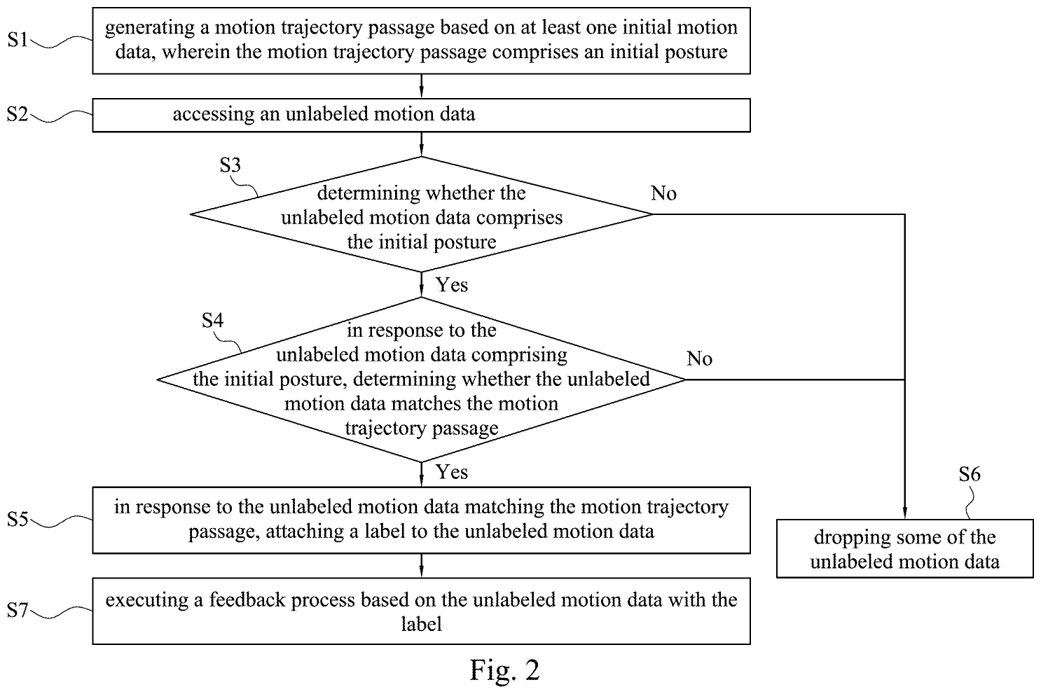

FIG. 2 is a flow chart showing a motion data labeling method according to some embodiments of the present disclosure. As shown in FIG. 2, in some embodiments, the motion data labeling method can be executed by the motion data labeling system 100 of FIG. 1. More specifically, the processor 120 accesses the computer readable instruction at the memory 110 to perform the application program so that the motion data labeling method can be established. In some embodiments, details of the motion data labeling method are introduced in following paragraphs.

Step S1: generating a motion trajectory passage based on at least one initial motion data, wherein the motion trajectory passage comprises an initial posture.

In some embodiments, the processor 120 of the motion data labeling system 100 can access the initial motion data at the database 200. The initial motion data can include a trajectory corresponding to these people performing some specific motions (e.g., acts of limbs or changes of postures). For example, in some embodiments, at the time that ten fitness coaches performing some standard arm works, the motion capture device 300 can capture motion data corresponding to the arm works of these fitness coaches, in order to generate the initial motion data.

In some embodiments, the processor 120 can analyze the initial motion data and build a motion trajectory passage based on the initial motion data. For example, according to the foregoing embodiment, the processor 120 can analyze the arm works of these fitness coaches to read the trajectories of this specific arm work. Therefore, the motion trajectory passage can be inducted from the trajectories of this specific arm work.

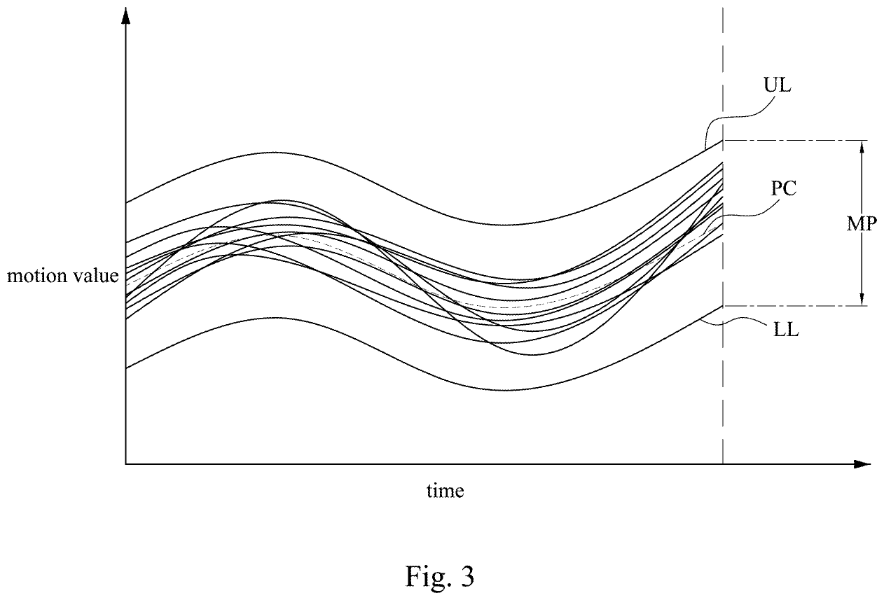

To allow for better understandings, reference is made to FIG. 3. FIG. 3 is a schematic diagram illustrating a motion trajectory passage according to some embodiments of the present disclosure. As shown in FIG. 3, in some embodiments, ten polylines illustrates the trajectories of these ten fitness coaches performing this specific arm work. The processor 120 can calculate a trajectory central line PC, an upper trajectory boundary UL and a lower trajectory boundary LL.

In particular, in some embodiments, the processor 120 can calculate a mean and a standard deviation of the values corresponding to these trajectories, along the time line that these trajectories being recorded. The processor 120 can use the mean to generate the trajectory central line PC, which can be understood as being an average line of the ten polylines. The processor 120 can determine the upper trajectory boundary UL based on a value of three standard deviations above the mean and determine the lower trajectory boundary UL based on a value of three standard deviations below the mean. These two boundaries are considered the upper limit and the lower limit of the ten polylines.

According to statistics of a normal distribution, the likelihood that these trajectories fall within the upper trajectory boundary UL and the lower trajectory boundary LL is 99.73%. The processor 120 can generate a motion trajectory passage MP based on the upper trajectory boundary UL and the lower trajectory boundary LL. As mentioned, since the upper trajectory boundary UL and the lower trajectory boundary LL are generated according to the standard motions of the fitness coaches, the motion trajectory passage MP can be understood as being a standard template of this specific arm work.

It is understood that, in foregoing embodiments, the exemplary values of the trajectory central line, the upper trajectory boundary and the lower trajectory boundary are not intended to limit the scope of the present disclosure. In some other embodiments, the processor 120 can retrieve the trajectory central line, the upper trajectory boundary and the lower trajectory boundary with alternative calculation methods. In some embodiments, an optimized model of the motion trajectory passage MP can be built by a training process using various machine learning algorithms (e.g., neural network algorithms, long-short term memory algorithms or the others) and mass initial motion data.

In some embodiments, the motion trajectory passage includes an initial posture. For example, the arm work performed by the fitness coaches can include an initial posture (e.g., positioning arms in front of the chest for a certain height). This initial posture can be considered an action of start of the entire arm work. Since the motion trajectory passage is formed according to the arm works of these fitness coaches, the motion trajectory passage should include this particular initial posture. It is noted that this exemplary embodiment is not intended to limit the scope of the present disclosure. Alternative initial postures can be possible.

Step S2: accessing an unlabeled motion data.

In some embodiments, the processor 120 of the motion data labeling system 100 can control the motion capture device 300 to capture some motion-related data. These motion-related data include at least one unlabeled motion data. It is noted that the unlabeled motion data corresponds to a motion substantially similar to the motion of the initial motion data (or an imitation version).

For instance, in some embodiments, when some fitness learners try to learn or imitate this specific arm work, the motion capture device 300 can capture the data corresponding to the learners' arm works to generate the unlabeled motion data. However, in some embodiments, parts of the data captured by the motion capture device 300 can be irrelevant to the motion of the initial motion data. In some other embodiments, the data captured by the motion capture device 300 can include several segments of a single learner (or several different learners) performing this specific arm work.

In some embodiments, the motion capture device 300 can capture (or controlled by other devices to capture) these motion-related data and store these motion-related data in the database 200. The processor 120 can access these motion-related data from the database 200 to obtain the unlabeled motion data.

Step S3: determining whether the unlabeled motion data comprises the initial posture. A positive result can lead to step S4. A negative result can lead to step S6.

In some embodiments, after the processor 120 accesses the unlabeled motion data, the processor 120 can determine whether the unlabeled motion data including information of the initial posture. As mentioned, since the initial posture is the start of the entire motion, the processor 120 can perform this determination in order to find out whether the unlabeled motion data can possibly include the motion corresponding to the motion trajectory passage MP.

Step S4: in response to the unlabeled motion data comprising the initial posture, determining whether the unlabeled motion data matches the motion trajectory passage. If there is a match, entering step S5. If there is no match, entering step S6.

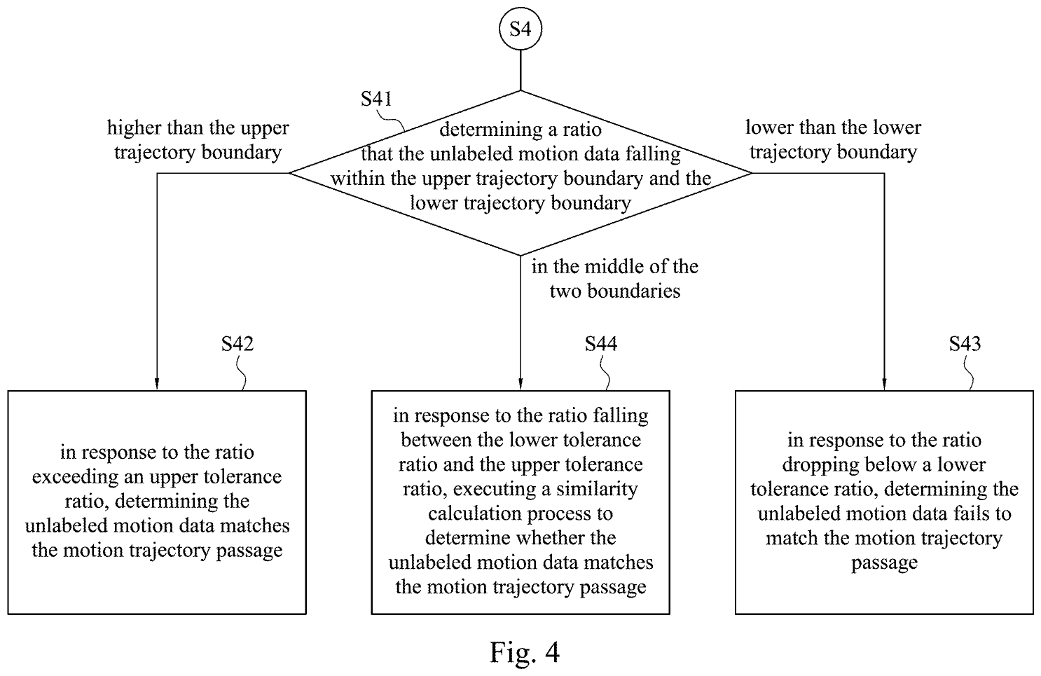

In some embodiments, after the processor 120 determines that the unlabeled motion data including the initial posture, the processor 120 can determine whether the motion corresponding to the unlabeled motion data matches the motion trajectory passage MP. More specifically, in some embodiments, the process that the processor 120 determines whether the unlabeled motion data matches the motion trajectory passage MP can include following steps. To allow for better understandings, reference is made to FIG. 4. FIG. 4 is a schematic diagram illustrating a motion data labeling method according to some embodiments of the present disclosure.

Step S41: determining a ratio that the unlabeled motion data falling within the upper trajectory boundary and the lower trajectory boundary. If the ratio exceeds the upper tolerance ratio, entering step S42. If the ratio dropping below the lower tolerance ratio, entering step S43.

In some embodiments, the processor 120 can analyze whether a motion corresponding to the unlabeled motion data falls within the motion trajectory passage MP. That is, whether the trajectory of this motion falls into the space between the upper trajectory boundary UL and the lower trajectory boundary LL of the motion trajectory passage MP.

As mentioned, since the accuracies of the learners' motions can be various, the processor 120 can calculate a ratio of the motion corresponding to the unlabeled motion data falling between the upper trajectory boundary UL and the lower trajectory boundary LL, in order to determine whether the unlabeled motion data falls within the motion trajectory passage MP.

In some embodiments, the processor 120 can compare the motion corresponding to the unlabeled motion data with the motion trajectory passage MP to find the ratio. For example, assuming the motion of the unlabeled motion data corresponds to a time length of N, the processor 120 can decide the ratio of the unlabeled motion data falling within the motion trajectory passage MP to be 85% if the trajectory of the unlabeled motion data is found falling between the upper trajectory boundary UL and the lower trajectory boundary LL with a time length of 0.85*N.

Step S42: in response to the ratio exceeding an upper tolerance ratio, determining the unlabeled motion data matches the motion trajectory passage. Next, entering step S5.

In some embodiments, if the ratio of the unlabeled motion data falling within the motion trajectory passage MP is higher than (or equal to) a predetermined upper tolerance ratio, the processor 120 can determine the unlabeled motion data matches the motion trajectory passage MP. For instance, the upper tolerance ratio can include but not limited to 90%.

Step S43: in response to the ratio dropping below a lower tolerance ratio, determining the unlabeled motion data fails to match the motion trajectory passage. Next, entering step S6.

In some embodiments, if the ratio of the unlabeled motion data falling within the motion trajectory passage MP is lower than (or equal to) a predetermined lower tolerance ratio, the processor 120 can determine the unlabeled motion data fails to match the motion trajectory passage MP. For instance, the lower tolerance ratio can include but not limited to 80%.

It is noted that a predetermine value of the lower tolerance ratio is lower than a predetermine value of the upper tolerance ratio. In this way, the processor 120 can exclude the unlabeled motion data with a lower ratio and keep the unlabeled motion data with a higher ratio.

Step S44: in response to the ratio falling between the lower tolerance ratio and the upper tolerance ratio, executing a similarity calculation process to determine whether the unlabeled motion data matches the motion trajectory passage.

In some embodiments, if the ratio of the unlabeled motion data falling within the motion trajectory passage MP is higher than the lower tolerance ratio but lower than the upper tolerance ratio, the processor 120 can further execute a similarity calculation process to determine whether the unlabeled motion data the motion trajectory passage MP.

According to the embodiment above, if the ratio of the unlabeled motion data falling within the motion trajectory passage MP is 85%, it indicates that the motion of the unlabeled motion data falls between the lower tolerance ratio (i.e., 80%) and the upper tolerance ratio (i.e., 90%). In this case, the processor 120 can execute the similarity calculation process to determine whether the unlabeled motion data matches the motion trajectory passage MP.

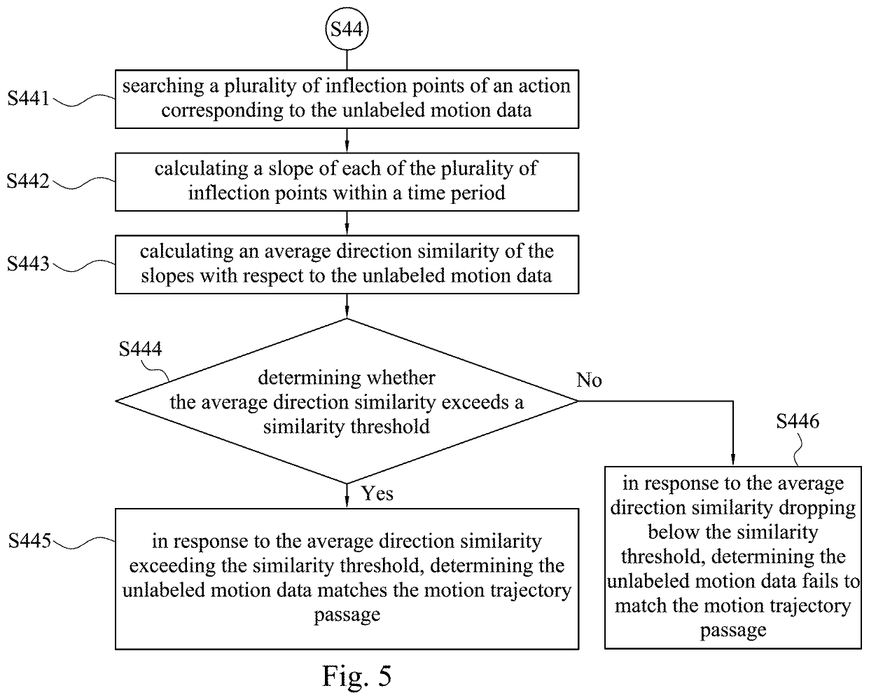

More specifically, the similarity calculation process of the processor 120 can include following steps. To allow for better understandings, reference is made to FIG. 5. FIG. 5 is a schematic diagram illustrating a motion data labeling method according to some embodiments of the present disclosure.

Step S441: searching a plurality of inflection points of an action corresponding to the unlabeled motion data.

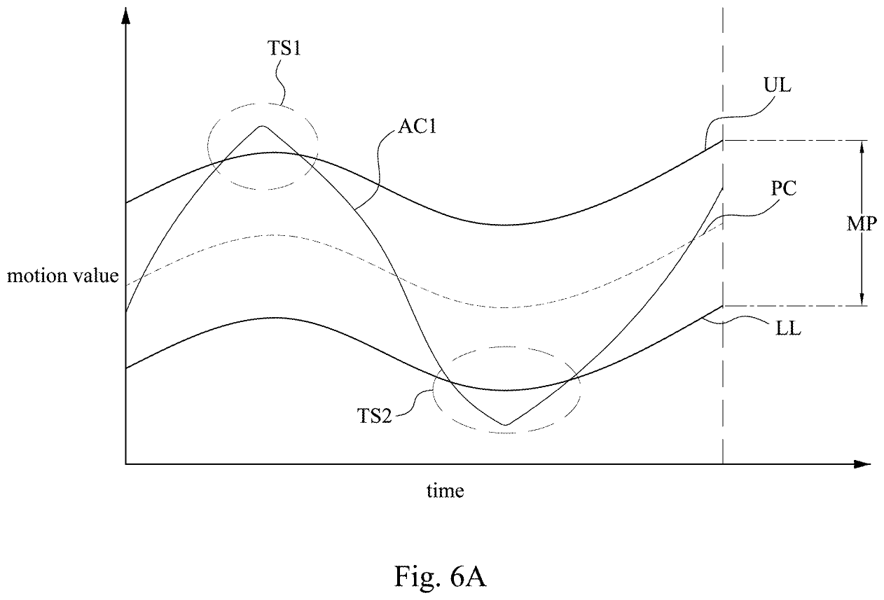

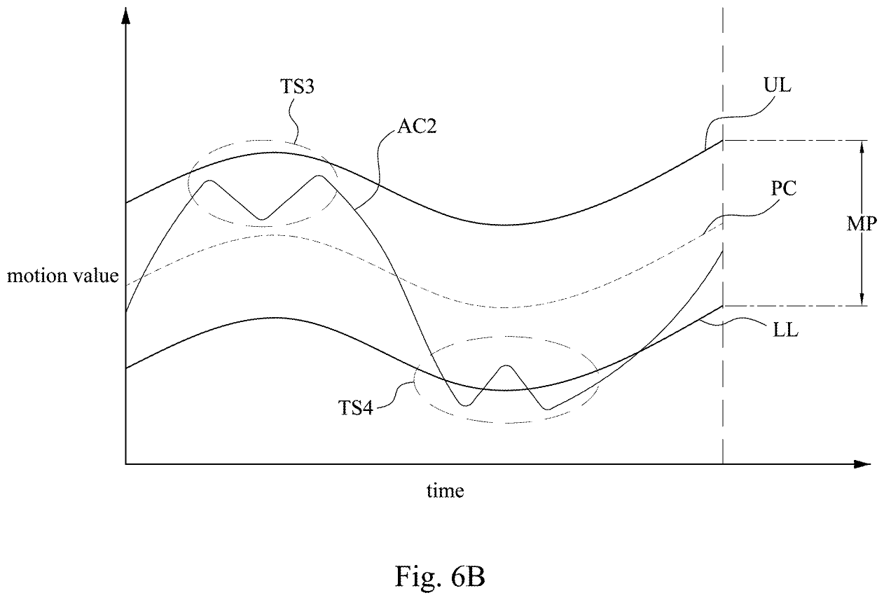

In some embodiments, the processor 120 can analyze the motion of the unlabeled motion data so as to perform the similarity calculation process targeting a plurality of inflection points of the motion. To allow for better understandings, references are made to FIG. 6A and FIG. 6B. FIG. 6A and FIG. 6B are schematic diagrams illustrating a similarity calculation process according to some embodiments of the present disclosure.

As shown in FIG. 6A, in some embodiments, the processor 120 analyzes an unlabeled motion data and retrieve a motion trajectory AC1. It is assumed that a ratio the motion trajectory AC1 falling between the upper trajectory boundary UL and the lower trajectory boundary LL is being determined in the middle of the lower tolerance ratio and the upper tolerance ratio. Moreover, the motion trajectory AC1 includes an inflection point TS1 and an inflection point TS2. Around the inflection point TS1, the motion trajectory AC1 crosses the upper trajectory boundary UL. Around the inflection point TS2, the motion trajectory AC1 crosses the lower trajectory boundary LL. In this embodiment, the processor 120 can perform the similarity calculation process focusing on the inflection point TS1 and the inflection point TS2 of the motion trajectory AC1.

As shown in FIG. 6B, in some embodiments, the processor 120 analyzes another unlabeled motion data and retrieve an motion trajectory AC2. It is assumed that a ratio the motion trajectory AC2 falling between the upper trajectory boundary UL and the lower trajectory boundary LL is being determined in the middle of the lower tolerance ratio and the upper tolerance ratio. Moreover, the motion trajectory AC2 includes an inflection point TS3 and an inflection point TS4. It is noted that, the inflection point TS3 and the inflection point TS4 of the motion trajectory AC2 are shown at places substantially similar to the inflection point TS1 and the inflection point TS2 of the motion trajectory AC1. However, it is obvious that the inflections occurred at inflection point TS3 and the inflection point TS4 are significantly different from the inflections occurred at the inflection point TS1 and the inflection point TS2. In this embodiment, the processor 120 can perform the similarity calculation process focusing on the inflection point TS3 and the inflection point TS4 of the motion trajectory AC2.

Step S442: calculating a slope of each of the plurality of inflection points within a time period.

In some embodiments, the processor 120 can calculate slopes of the motion trajectory AC1, in a specific time period, around the inflection point TS1 and the inflection point TS2. Also, the processor 120 can calculate slopes of the motion trajectory AC2, in the specific time period, around the inflection point TS3 and the inflection point TS4. It is noted that this specific time period refers to a period of time, before and after, the inflection point TS1 (or the inflection points TS2, TS3, TS4) being recorded. It is understood that this specific time period being used for slope calculation can be various based on different time lengths of the recording of the motion trajectories.

Step S443: calculating an average direction similarity of the slopes with respect to the unlabeled motion data.

In some embodiments, the processor 120 can calculate an average direction similarity between the motion trajectory AC1 and the motion trajectory passage MP around the inflection point TS1 and the inflection point TS2, and calculate an average direction similarity between the motion trajectory AC2 and the motion trajectory passage MP around the inflection point TS3 and the inflection point TS4. In some embodiments, the average direction (α) can be calculated based on the following formula:

$$α = ( \frac{1}{axis} ) {\sum }_{axis = 1}^{n} sin ( A , B ) = cos ( θ ) = \frac{A \times B}{‖ A ‖ \times ‖ B ‖}$$

In the formula of α, axis represents the axis orientation of the trajectory around the inflection point and the inflection point. A represents a vector value of the trajectory before the inflection point (e.g., the inflection point TS1˜TS4). B represents a vector value of the trajectory after the inflection point (e.g., the inflection point TS1˜TS4). θ represents an angle between the vector A and the vector B. Therefore, the average direction formula can be understood with an example focusing on the inflection point TS1, which is shown below: following the motion trajectory AC1 and targeting a first time point before the inflection point TS1; following the motion trajectory AC1 and targeting a second time point after the inflection point TS1; calculate the vector A of the motion trajectory AC1 directing from the first time point to the inflection point TS1; calculate the vector B of the motion trajectory AC1 directing from the inflection point TS1 to the second time point; calculate a cosine value of the inflection point TS1 according to the vector A and the vector B. In this case, the average direction is a ratio of the orientation of an inflection point and the orientation of another corresponding inflection point (e.g., between the inflection point TS1 of the motion trajectory AC1 and the corresponding inflection point of the motion trajectory passage MP).

Step S444: determining whether the average direction similarity exceeds a similarity threshold. A positive result can lead to step S445. A negative result can lead to step S446.

It is noted that the motion corresponding to the unlabeled motion data is an imitation act of the motion of the initial motion data. Therefore, there could be some inflection points in the motion trajectory passage MP at the places similar to the inflection point TS1 and the inflection point TS2 of the motion trajectory AC1. In an ideal unlabeled motion data, the way that the motion trajectory AC1 moves around the inflection point TS1 and the inflection point TS2 should be substantially identical to the way the motion trajectory passage MP moves. That is to say, the average direction similarity of the motion trajectory AC1 around the inflection point TS1 and the inflection point TS2 should be close to the average direction similarity of the motion trajectory passage MP around these inflection points. In this manner, the processor 120 can determine whether the average direction similarities of the motion trajectory AC1 around the inflection point TS1 and the inflection point TS2 exceed a similarity threshold. For example, in some embodiments, the similarity threshold can include but not limited to 60%.

Step S445: in response to the average direction similarity exceeding the similarity threshold, determining the unlabeled motion data matches the motion trajectory passage. Then, entering step S5.

In some embodiments, if it is determined that the slopes of the motion trajectory AC1 around the inflection point TS1 and the inflection point TS2 are higher than (or equal to) the similarity threshold (e.g., 60%) with respect to the motion trajectory passage MP, the processor 120 determines the unlabeled motion data matches the motion trajectory passage MP.

For example, as shown in FIG. 6A, though the motion trajectory AC1 got out of the motion trajectory passage MP around the inflection point TS1 and the inflection point TS2, the slopes of the motion trajectory AC1 around the inflection point TS1 and the inflection point TS2 are closed to the slopes of the motion trajectory passage MP around corresponding inflection points. Comparing to the motion trajectory AC2 of FIG. 6B, it is more likely that the average direction similarity between the motion trajectory AC1 and the motion trajectory passage MP exceeds (or equals to) the similarity threshold. Therefore, the processor 120 can determine the unlabeled motion data corresponding to the motion trajectory AC1 matches the motion trajectory passage MP.

Step S446: in response to the average direction similarity dropping below the similarity threshold, determining the unlabeled motion data fails to match the motion trajectory passage. Then, entering step S6.

In some embodiments, if the average direction similarity between the slopes of the motion trajectory AC1, around the inflection point TS1 and the inflection point TS2, and the slopes of and the motion trajectory passage MP around the substantially places is lower than the similarity threshold (e.g., 60%), the processor 120 can determine the unlabeled motion data fails to match the motion trajectory passage MP.

FIG. 6B shows that, although the motion trajectory AC2 does not go out of the motion trajectory passage MP a lot around the inflection point TS3 and the inflection point TS4, the motion trajectory AC2 goes to a way substantially opposite to the motion trajectory passage MP does, around the inflection point TS3 and the inflection point TS4. This can cause a lower average direction similarity. Therefore, comparing to the motion trajectory AC1 of FIG. 6A, it is more likely that the average direction similarity between the motion trajectory AC2 and the motion trajectory passage MP would be lower than (or equal to) the similarity threshold. In this case, the processor 120 can determine the unlabeled motion data corresponding to the motion trajectory AC2 fails to match the motion trajectory passage MP.

It is noted that, when the processor 120 executes mentioned step S4, the processor 120 can calibrate the unlabeled motion data with the motion trajectory passage MP using dynamic time wrapping if the time length of the unlabeled motion data is different from the time length of the motion trajectory passage MP (e.g., the time length of the unlabeled motion data is longer or shorter than the time length of the motion trajectory passage MP). In general, the processor 120 can map the timeline of the unlabeled motion data into the time length of the motion trajectory passage MP (i.e., stretching or compressing the trajectory of the unlabeled motion data according to a ratio of related time lengths) in order to calibrate the unlabeled motion data. In this manner, the processor 120 can compare the unlabeled motion data with each other based on the same standard.

Step S5: in response to the unlabeled motion data matching the motion trajectory passage, attaching a label to the unlabeled motion data.

In some embodiments, if the processor 120 determines an unlabeled motion data matching the motion trajectory passage MP according to the mentioned processes, the processor 120 can attach a label to this unlabeled motion data. This label can be considered a mark of authentication. It means that the similarity of the unlabeled motion data and the motion trajectory passage MP successfully passes the examination of the processor 120. In some embodiments, the processor 120 can store the unlabeled motion data having the label attached thereon (e.g., the unlabeled motion data corresponding to the motion trajectory AC1) in at least one storage device (e.g., the memory 110 or the database 200).

Step S6: dropping some of the unlabeled motion data.

In some embodiments, if the processor 120 determines an unlabeled motion data failing to match the motion trajectory passage MP according to the mentioned processes, the processor 120 can drop the unlabeled motion data (e.g., drop the unlabeled motion data corresponding to the motion trajectory AC2). In some embodiments, the processor 120 can drop the unlabeled motion data by cancelling it. In some embodiments, the processor 120 can store the unlabeled motion data in another storage device, temporarily, for further examination.

Step S7: executing a feedback process based on the unlabeled motion data with the label.

In some embodiments, the processor 120 can executes a feedback process based on the unlabeled motion data with the label. For example, the feedback process can be a comparison process implemented via a specific display device, which can provide the student to observe the difference between his/her arm work and the standard arm work. Alternatively, the feedback process can be a scoring process implemented by a specific display device that can give the student feedback on the similarity between his/her arm work and the standard arm work. In addition, the feedback process can be a practice program implemented by a specific display device, which can examine the arm works of the student and check whether the similarity between he students arm work and the standard arm work two exceeds a specific threshold. However, it is understood that the feedback process of the present disclosure is not limited to the above-mentioned implementations. The purpose of the present disclosure is to provide a method that can label effective data for motion model training. The motion model trained by the data can be preferably used as the basis for an identification process or a scoring process.

In some embodiments, the motion data labeling system 100 of the present disclosure can be employed in a real-time tutorial, in order to provide an efficient way to manage the tutorial and better experience to the participants. For example, in a fitness class, each student and coach can wear the motion capture device 300 (or devices provide the same functions). These devices can be communicatively coupled to the motion data labeling system 100 via wireless connections (e.g., Bluetooth or the others). When the class takes place, the motion capture device 300 worn by the coach can keep collecting motion data from the coach and send the data to the motion data labeling system 100 so that the model of the motion trajectory passage MP can be trained. The motion capture device 300 worn by the student can keep collecting motion data from the student and send the data to the motion data labeling system 100. The motion data labeling system 100 can determine whether the motion of the student matches the motion trajectory passage MP (including the motion itself, the tempo, the time factors, or the others). The motion data labeling system 100 can further introduce a scoring method correspondingly. Furthermore, the coach can decide whether to give more intensive lessons based on the scores of the students.

It is noted that the processor 120 of the motion data labeling system 100 can execute the steps S3-S6, repeatedly, so as to filter some effective motion data from a big data of unlabeled motions based on specific standards (e.g., matching the motion trajectory passage MP).

According to the foregoing embodiment, the present invention provides a motion data labelling system, a motion data labelling method, and a non-transitory computer readable medium, which can build a standard motion trajectory passage, and determine whether the motion data matches the motion trajectory passage, and further label the motion data that passed the examination. Based on this mechanism, the system can automatically label the motion data that fits to the standard, which can improve the efficiency of data processing.

In foregoing embodiments, the motion data labeling system 100 of present disclosure has multiple functional blocks or modules. As will be appreciated by persons skilled in the art, in some embodiments, these functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. However, the scope of present disclosure is not limited thereto.

Although the detailed embodiments of the present disclosure have been disclosed above, other possible implementations are not excluded. The scope of the present disclosure can be referenced to the appended claims, and is not limited by the foregoing embodiments.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A motion data labeling system, comprising:
a memory stores at least one instruction; and
a processor, communicatively coupled to the processor, wherein the processor is configured to access and execute the at least one instruction to perform the following:
generating a motion trajectory passage based on at least one initial motion data, wherein the motion trajectory passage comprises an initial posture;
accessing an unlabeled motion data;
determining whether the unlabeled motion data comprises the initial posture;
in response to the unlabeled motion data comprising the initial posture, determining whether the unlabeled motion data matches the motion trajectory passage; and
in response to the unlabeled motion data matching the motion trajectory passage, attaching a label to the unlabeled motion data.

2. The motion data labeling system of claim 1, wherein the motion trajectory passage comprises an upper trajectory boundary and a lower trajectory boundary, and the processor determines whether the unlabeled motion data matching the motion trajectory passage based on the upper trajectory boundary and the lower trajectory boundary.

3. The motion data labeling system of claim 2, wherein the processor determining whether the unlabeled motion data matches the motion trajectory passage comprising:
determining a ratio that the unlabeled motion data falling within the upper trajectory boundary and the lower trajectory boundary;
in response to the ratio exceeding an upper tolerance ratio, determining the unlabeled motion data matches the motion trajectory passage;
in response to the ratio dropping below a lower tolerance ratio, determining the unlabeled motion data fails to match the motion trajectory passage, wherein the lower tolerance ratio is lower than the upper tolerance ratio; and
in response to the ratio falling between the lower tolerance ratio and the upper tolerance ratio, executing a similarity calculation process to determine whether the unlabeled motion data matches the motion trajectory passage.

4. The motion data labeling system of claim 3, wherein the processor executing the similarity calculation process comprising:
searching a plurality of inflection points of an action corresponding to the unlabeled motion data;
calculating a slope of each of the plurality of inflection points within a time period;
calculating an average direction similarity of the slopes with respect to the unlabeled motion data;
determining whether the average direction similarity exceeds a similarity threshold;
in response to the average direction similarity exceeding the similarity threshold, determining the unlabeled motion data matches the motion trajectory passage; and
in response to the average direction similarity dropping below the similarity threshold, determining the unlabeled motion data fails to match the motion trajectory passage.

5. The motion data labeling system of claim 4, wherein the processor drops the unlabeled motion data in response to the unlabeled motion data failing to match the motion trajectory passage.

6. The motion data labeling system of claim 4, wherein the processor adjusts the motion trajectory passage in response to the average direction similarity exceeding the similarity threshold.

7. The motion data labeling system of claim 3, wherein the processor drops the unlabeled motion data in response to the unlabeled motion data failing to match the motion trajectory passage.

8. The motion data labeling system of claim 1, wherein the processor executes a feedback process based on the unlabeled motion data with the label.

9. A motion data labeling method, comprising:
generating a motion trajectory passage based on at least one initial motion data, wherein the motion trajectory passage comprises an initial posture;
accessing an unlabeled motion data;
determining whether the unlabeled motion data comprises the initial posture;
in response to the unlabeled motion data comprising the initial posture, determining whether the unlabeled motion data matches the motion trajectory passage; and
in response to the unlabeled motion data matching the motion trajectory passage, attaching a label to the unlabeled motion data.

10. The motion data labeling method of claim 9, further comprising:
determining a ratio that the unlabeled motion data falling within an upper trajectory boundary and a lower trajectory boundary;
in response to the ratio exceeding an upper tolerance ratio, determining the unlabeled motion data matches the motion trajectory passage;
in response to the ratio dropping below a lower tolerance ratio, determining the unlabeled motion data fails to match the motion trajectory passage, wherein the lower tolerance ratio is lower than the upper tolerance ratio; and
in response to the ratio falling between the lower tolerance ratio and the upper tolerance ratio, executing a similarity calculation process to determine whether the unlabeled motion data matches the motion trajectory passage.

11. The motion data labeling method of claim 10, wherein executing the similarity calculation process comprising:
searching a plurality of inflection points of an action corresponding to the unlabeled motion data;
calculating a slope of each of the plurality of inflection points within a time period;
calculating an average direction similarity of the slopes with respect to the unlabeled motion data;
determining whether the average direction similarity exceeds a similarity threshold;
in response to the average direction similarity exceeding the similarity threshold, determining the unlabeled motion data matches the motion trajectory passage; and
in response to the average direction similarity ratio dropping below the similarity threshold, determining the unlabeled motion data fails to match the motion trajectory passage.

12. The motion data labeling method of claim 11, further comprising:
dropping the unlabeled motion data in response to the unlabeled motion data failing to match the motion trajectory passage.

13. The motion data labeling method of claim 11, further comprising:
adjusting the motion trajectory passage in response to the average direction similarity exceeding the similarity threshold.

14. The motion data labeling method of claim 9, further comprising:
executing a feedback process based on the unlabeled motion data with the label.

15. A non-transitory computer readable medium storing at least one computer readable instruction that, when executed by a processor, causes the processor to perform steps comprising:
generating a motion trajectory passage based on at least one initial motion data, wherein the motion trajectory passage comprises an initial posture;
accessing an unlabeled motion data;
determining whether the unlabeled motion data comprises the initial posture;
in response to the unlabeled motion data comprising the initial posture, determining whether the unlabeled motion data matches the motion trajectory passage; and
in response to the unlabeled motion data matching the motion trajectory passage, attaching a label to the unlabeled motion data.

16. The non-transitory computer readable medium of claim 15, wherein the processor further performs steps comprising:
determining a ratio that the unlabeled motion data falling within an upper trajectory boundary and a lower trajectory boundary;
in response to the ratio exceeding an upper tolerance ratio, determining the unlabeled motion data matches the motion trajectory passage;
in response to the ratio dropping below a lower tolerance ratio, determining the unlabeled motion data fails to match the motion trajectory passage, wherein the lower tolerance ratio is lower than the upper tolerance ratio; and
in response to the ratio falling between the lower tolerance ratio and the upper tolerance ratio, executing a similarity calculation process to determine whether the unlabeled motion data matches the motion trajectory passage.

17. The non-transitory computer readable medium of claim 16, wherein the processor performs the similarity calculation process comprising:
searching a plurality of inflection points of an action corresponding to the unlabeled motion data;
calculating a slope of each of the plurality of inflection points within a time period;
calculating an average direction similarity of the slopes with respect to the unlabeled motion data;
determining whether the average direction similarity exceeds a similarity threshold;
in response to the average direction similarity exceeding the similarity threshold, determining the unlabeled motion data matches the motion trajectory passage; and
in response to the average direction similarity ratio dropping below the similarity threshold, determining the unlabeled motion data fails to match the motion trajectory passage.

18. The non-transitory computer readable medium of claim 16, wherein the processor further performs steps comprising:
dropping the unlabeled motion data in response to the unlabeled motion data failing to match the motion trajectory passage.

19. The non-transitory computer readable medium of claim 17, wherein the processor further performs steps comprising:
adjusting the motion trajectory passage in response to the average direction similarity exceeding the similarity threshold.

20. The non-transitory computer readable medium of claim 15, wherein the processor further performs steps comprising:
executing a feedback process based on the unlabeled motion data with the label.
